(19) United States
(12) Patent Application Publication
(10) Pub. No.: US 2012/0255537 A1
(43) Pub. Date: Oct. 11, 2012

(54) ADJUSTABLE PORTABLE GRILL

(76) Inventor: DAMAN PREET SINGH KANWAR, Glendale, CA (US)

(21) Appl. No.: 13/440,681

(22) Filed: Apr. 5, 2012

Related U.S. Application Data
(60) Provisional application No. 61/471,915, filed on Apr. 5, 2011.

(51) Int. Cl. A47J 37/07; A47J 37/04

(52) U.S. Cl. 126/25 AA; 126/25 A; 99/421 HV

(57) ABSTRACT

The present invention is an adjustable portable grill that includes a detachable gear system, a height adjusting handle, a plurality of adjustable detachable legs and a fire bowl with two sides that includes a top, a top edge, a back edge, a grill surface, a plurality of small skewers and a rotisserie. A second embodiment of the present invention can also include an inverted t-shaped holder, a height adjusting handle, a plurality of adjustable detachable legs and a fire bowl.

This application claims priority to U.S. Provisional Application 61/471,915 filed on Apr. 5, 2011, the entire disclosure of which is incorporated by reference.

### TECHNICAL FIELD & BACKGROUND

Barbeque grilling has always been a favorite summer and spring activity, particularly in the United States. The present invention generally relates to a grill. More specifically, the invention is an adjustable portable grill.

It is an object of the invention to provide an adjustable portable grill that is portable and can be used for conventional grilling as well as an automated rotisserie with a plurality of easy to use attachments.

It is an object of the invention to provide an adjustable portable grill that enhances an outdoor BBQ experience that includes an automated rotisserie controlled by a battery-operated motor and/or fully electric motor well-suited for a plurality of outdoor events such as a picnic, a camping activity and other suitable outdoor events.

It is an object of the invention to provide an adjustable portable grill that has a plurality of skewers that can be rotated manually or automatically with a battery-operated motor or a hardwire power source.

It is an object of the invention to provide an adjustable portable grill that includes an easy to use height adjuster that helps adjust a distance of a plurality of rotating skewers from a fire bowl even while one or more pieces of food such as meat is on the rotating skewers are getting cooked without bringing the rotating skewers out thereby avoiding any added work or inconvenience.

What is really needed is an adjustable portable grill that is portable and can be used for conventional grilling as well as an automated rotisserie with a plurality of easy to use attachments that enhances an outdoor BBQ experience that includes an automated rotisserie controlled by a battery-operated motor and/or fully electric motor well-suited for a plurality of outdoor events such as a picnic, a camping activity and other suitable outdoor events that has a plurality of skewers that can be rotated manually or automatically with a battery-operated motor or a hardwire power source that includes an easy to use height adjuster that helps adjust a distance of a plurality of rotating skewers from a fire bowl even while one or more pieces of food such as meat is on the rotating skewers are getting cooked without bringing the rotating skewers out thereby avoiding any added work or inconvenience.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an environmental front perspective view of an adjustable portable grill, in accordance with one embodiment of the present invention.

FIG. 2 illustrates a side view of an adjustable portable grill, in accordance with one embodiment of the present invention.

FIG. 3 illustrates a side view of an adjustable portable grill, in accordance with one embodiment of the present invention.

FIG. 4A illustrates a top and side view of a fire bowl of an adjustable portable grill, in accordance with one embodiment of the present invention.

FIG. 4B illustrates a top and side view of a fire bowl of an adjustable portable grill, in accordance with one embodiment of the present invention.

FIG. 5A illustrates a side view of a forked fish skewer of an adjustable portable grill, in accordance with one embodiment of the present invention.

FIG. 5B illustrates a front view of a plurality of skewers on an adjustable portable grill, in accordance with one embodiment of the present invention.

FIG. 6 illustrates a front and top view of a fire bowl of an adjustable portable grill, in accordance with one embodiment of the present invention.

FIG. 7 illustrates a front view of a meat cage grill surface of an adjustable portable grill, in accordance with one embodiment of the present invention.

FIG. 8 illustrates a front view of a rotisserie of an adjustable portable grill, in accordance with one embodiment of the present invention.

FIG. 9A illustrates a front view of an electric powered motor of an adjustable portable grill, in accordance with one embodiment of the present invention.

FIG. 9B illustrates a front view of a battery powered motor of an adjustable portable grill, in accordance with one embodiment of the present invention.

FIG. 9C illustrates a front view of an electric powered motor of an adjustable portable grill, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

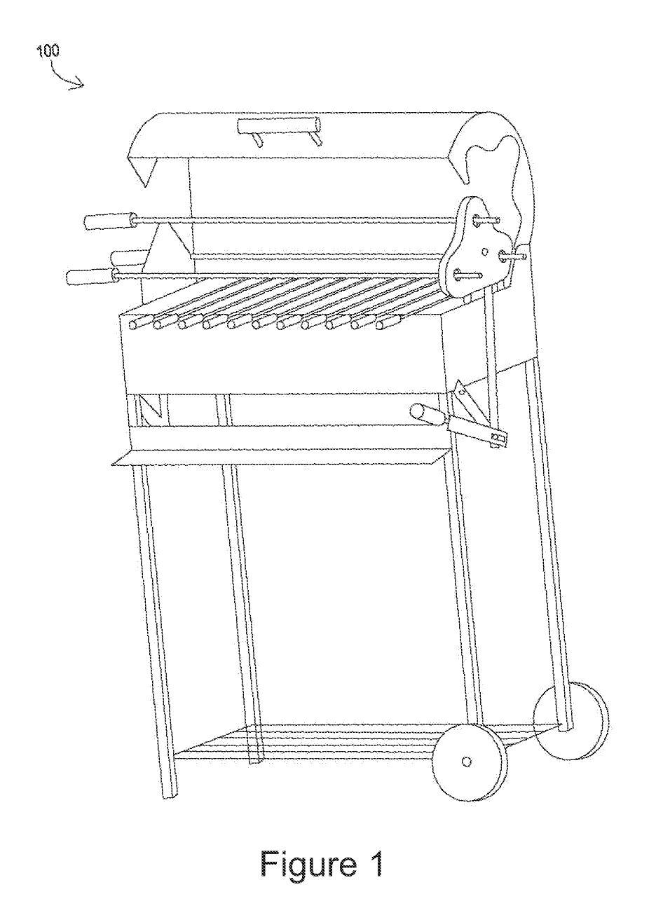

FIG. 1 illustrates an environmental front perspective view of an adjustable portable grill 100, in accordance with one embodiment of the present invention.

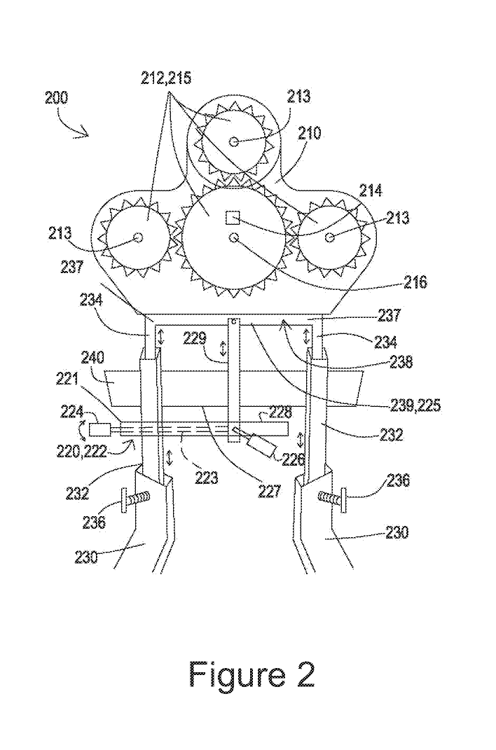

The adjustable portable grill 100 illustrated in FIG. 1 is an assembled adjustable portable grill 100. The plurality of components and embodiments of the adjustable portable grill 100 are described and illustrated in the subsequent FIGS. 2-8.

FIG. 2 illustrates a side view of an adjustable portable grill 200, in accordance with one embodiment of the present invention.

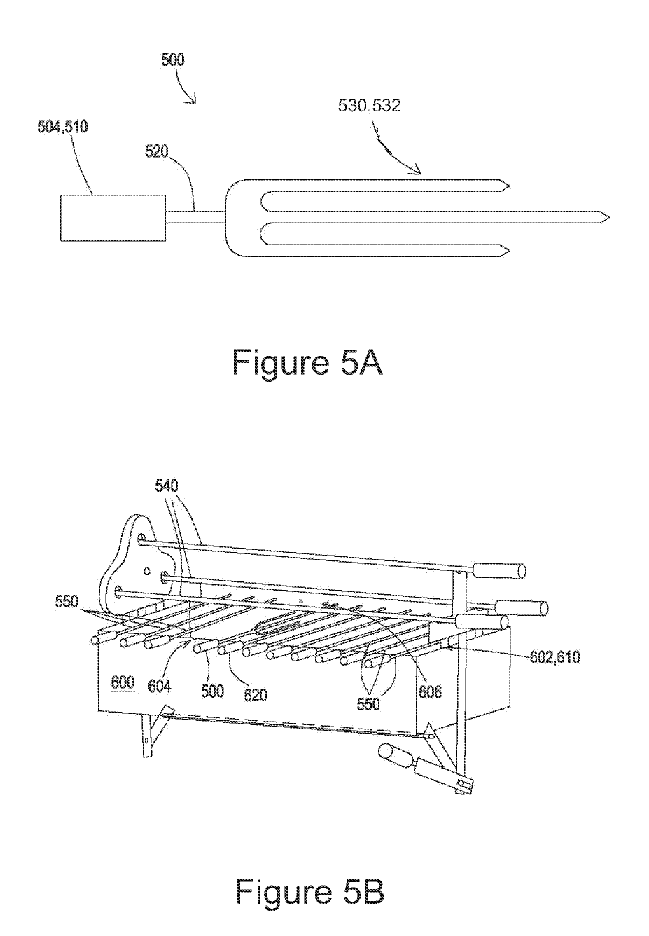

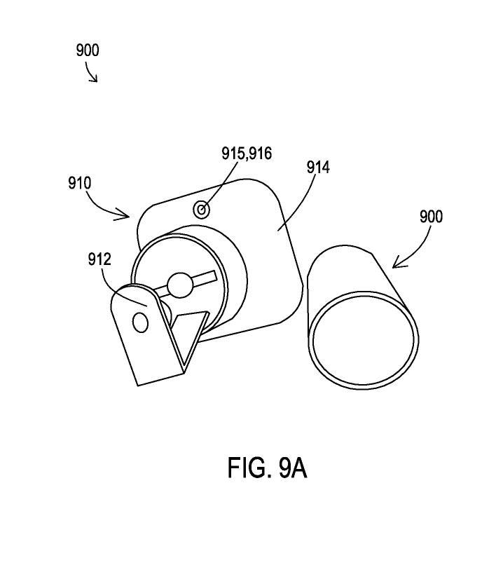

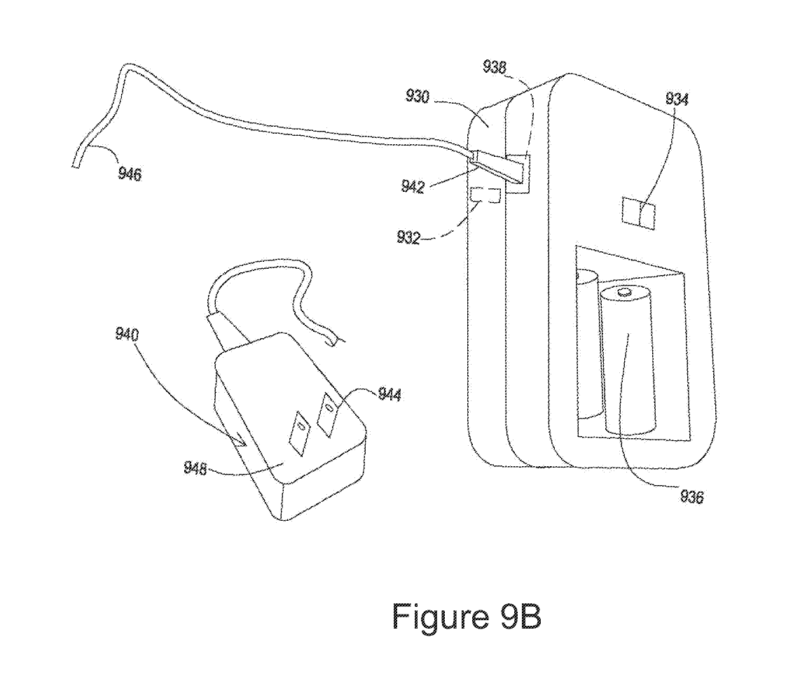

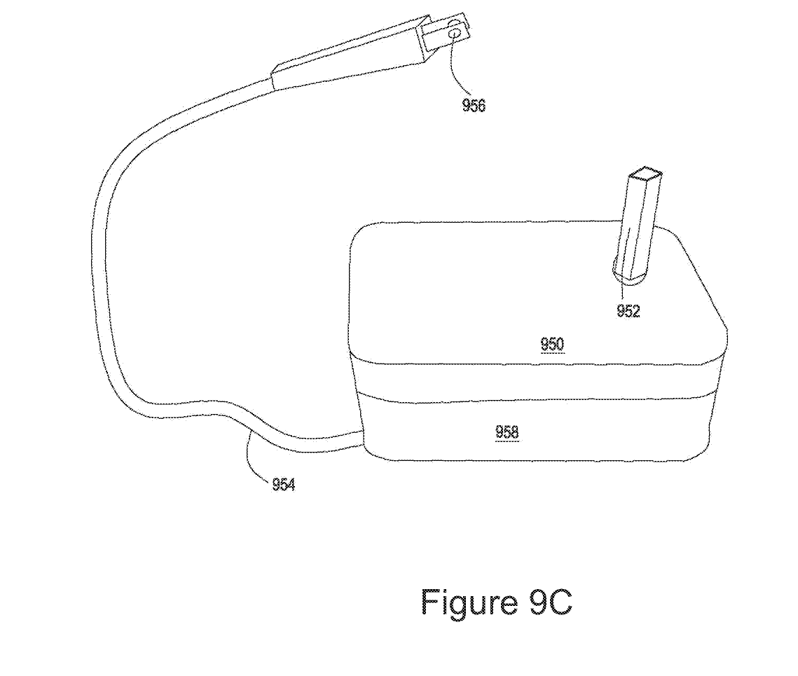

The adjustable portable grill 200 illustrated and described in FIG. 2 includes a detachable gear system 210, a height adjusting handle 220, a plurality of adjustable detachable legs 230 and a fire bowl 240. The detachable gear system 210 includes a plurality of interlocking gears 212, a motor holder 214 and a horizontal stem 216. The detachable gear system 210 can be attached to either side of the fire bowl 240 to rotate and accommodate any large skewers (FIG. 5, 500). The interlocking gears 212 include 3 large moving apertures or slots 213 that accommodate 3 large skewers 500. There are 4 gears 215 illustrated in FIG. 2 although the detachable gear system 210 can utilize any suitable number of gears such as 3, 5 or 6 gears. The motor holder 214 contains and secures an electric powered motor (FIG. 9, 900) utilized to power the detachable gear system 210. The horizontal stem 216 is inserted into an aperture (FIG. 9, 910) of the electric powered motor 900 to allow the electric powered motor 900 to rotate the 4 gears 215 of the detachable gear system 210.

The height adjusting handle 220 includes a generally rectangular casing 222 with a distal end 221 and an outer side 223, a vertical moving handle 224 disposed on the distal end 221 of the rectangular casing 222, a screw handle 226, a horizontal slot 228 disposed on the outer side 223 and a vertical movable joint 229 that is placed in the horizontal slot 228 and can be horizontally adjustably moved within the horizontal slot 228. A bottom rod 227 is also provided to attach the movable joint 229 to the fire bowl 240.

The adjustable detachable legs 230 include a hollow interior 232, a hollow tube 234 movably inserted into the hollow interior 232 of each adjustable detachable leg 230, a manual screw 236 that secures each adjustable detachable leg 230 at a desired height and an inverted u-shaped tube 238 with two ends 237 and a middle portion 239 where the two ends 237 are inserted into the hollow tubes 234 of the adjustable detachable legs 230. The vertical movable joint 229 has a distal end 225 that is attached to the middle portion 239 of the inverted u-shaped tube 238. The detachable gear system 210 is also disposed on the inverted u-shaped tube 238 and is height adjustable by the adjustable detachable legs 230.

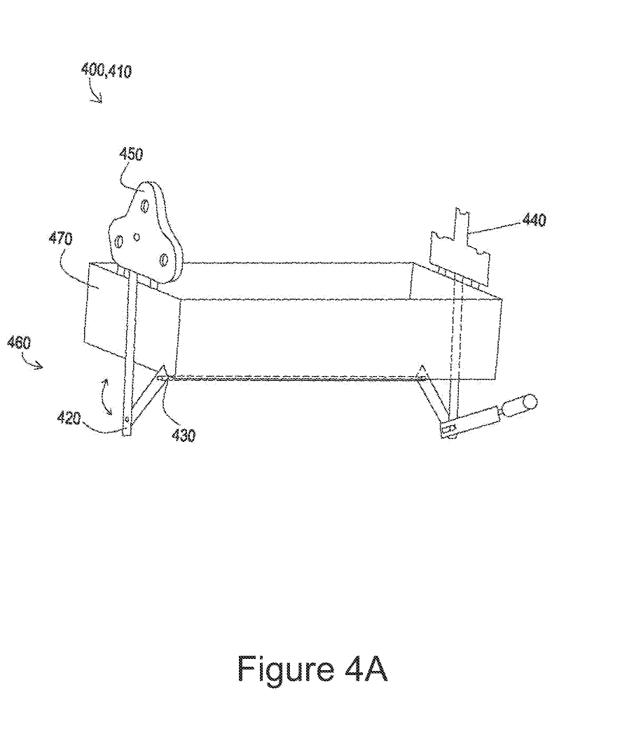

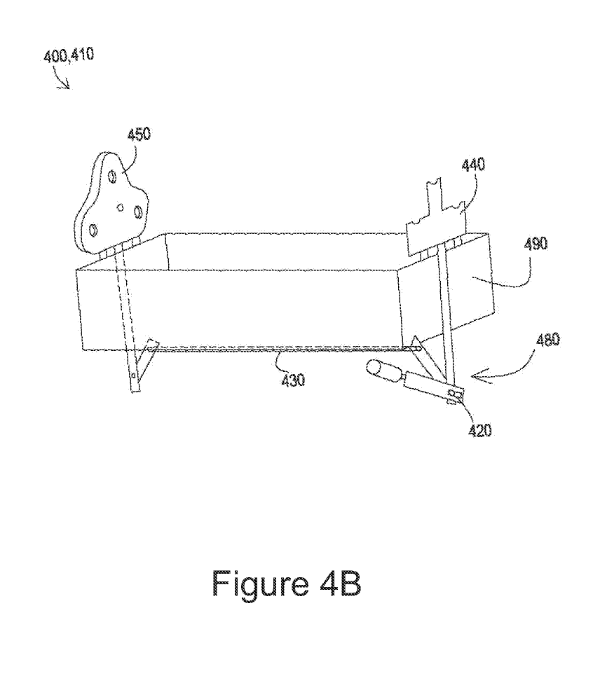

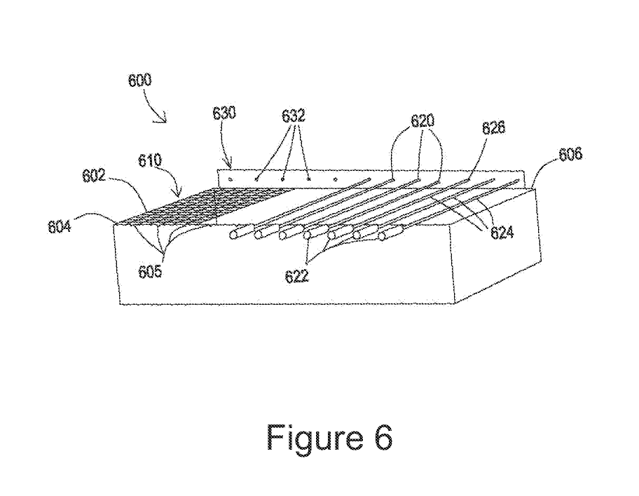

The fire bowl 240 is further described in FIGS. 4A, 4B and 6.

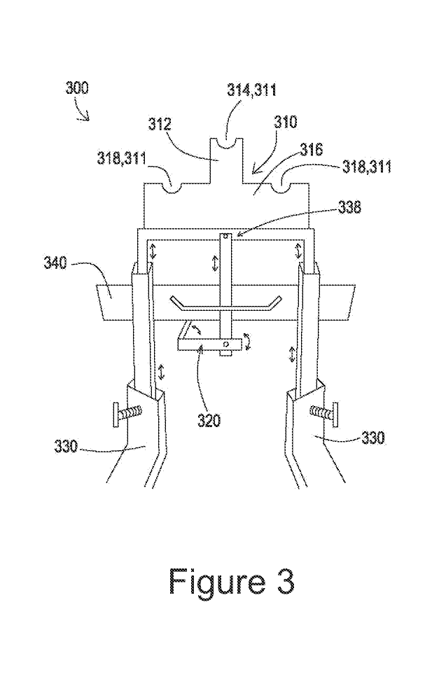

FIG. 3 illustrates a side view of an adjustable portable grill 300, in accordance with one embodiment of the present invention.

The adjustable portable grill 300 illustrated and described in FIG. 3 has the same components as the adjustable portable grill 200 illustrated and described in FIG. 2 and its description accept for the detachable gear system 210 and its components. The adjustable portable grill 300 in FIG. 3 does include the same height adjusting handle 320, plurality of adjustable detachable legs 330 and fire bowl 340 as the height adjusting handle 220, plurality of adjustable detachable legs 230 and fire bowl 240 as described and illustrated in FIG. 2 and its description.

The adjustable portable grill 300 has an inverted t-shaped holder 310 with a perpendicular horizontal stem 312 with a distal end 314 and a horizontal portion 316 with two ends 318. A slot 311 that accommodates and removably secures a large skewer 500 is disposed on the distal end 314 of the perpendicular horizontal stem 312 and disposed on each end 318 of the horizontal portion 316. The inverted t-shaped holder 310 is disposed on a u-shaped tube 338 that is the same u-shaped tube 238 illustrated and described in FIG. 2 and its description.

FIG. 4A illustrates a front and top view of a fire bowl 410 of an adjustable portable grill 400, in accordance with one embodiment of the present invention.

The fire bowl 410 includes a vertical movable joint 420, a bottom rod 430, an inverted t-shaped holder 440 and a detachable gear system 450, all of which are the same as the vertical movable joint 229, the bottom rod 227, the inverted t-shaped holder 310 and the detachable gear system 210 described and illustrated in FIG. 2 and FIG. 3 and their description. In FIG. 4A, the vertical movable, joint 420, the bottom rod 430 and the detachable gear system 450 form a height adjuster 460 that is disposed on the left hand side 470 of the fire bowl 410 of the adjustable portable grill 400.

FIG. 4B illustrates a top side view of a fire bowl 410 of an adjustable portable grill 400, in accordance with one embodiment of the present invention. The fire bowl 410 includes a vertical movable joint 420, a bottom rod 430 and an inverted t-shaped holder 440, all of which are the same as the vertical movable joint 229, the bottom rod 227 and the inverted t-shaped holder 310 described and illustrated in FIG. 2 and FIG. 3 and their description. In FIG. 4B, the vertical movable joint 420, the bottom rod 430 and the inverted t-shaped holder 440 form a height adjuster 480 that is disposed on the right hand side 490 of the fire bowl 410 of the adjustable portable grill 400.

FIG. 5A illustrates a side view of a forked fish skewer 500 of an adjustable portable grill, in accordance with one embodiment of the present invention.

The forked fish skewer 500 with a proximal end 504 includes a handle 510, a stem 520 and a plurality of prongs 530. The handle 510 is disposed on a proximal end 504 of the forked fish skewer 500. The stem 520 extends from the handle 510. The prongs 530 extend from the stem 520 and include 3 prongs 532 as illustrated in FIG. 5 but can include any suitable number of prongs such as 2 prongs or 4 prongs.

FIG. 5B illustrates a front view of a plurality of skewers on an adjustable portable grill, in accordance with one embodiment of the present invention.

The skewers include the forked fish skewer 500 from FIG. 5A, a plurality of large straight skewers 540 and a plurality of large flat skewers 550. The forked fish skewer 500 is the same forked fish skewer 500 illustrated and described in FIG. 5A and its description and has all of the same features of the forked fish skewer 500 in FIG. 5A. The forked fish skewer 500 can be utilized on the rotisserie (FIG. 6, 630) or the inverted t-shaped holder 440 and the detachable gear system 450 that was previously illustrated and described in FIGS. 4A and 4B and its description. Three large straight skewers 540 are illustrated in FIG. 5B as running across and being removably secured to the inverted t-shaped holder 440 and the detachable gear system 450 that was previously illustrated and described in FIGS. 4A and 4B and its description although one or two large straight skewers 540 can be run across and be removably secured to the inverted t-shaped holder 440 and the detachable gear system 450. There are seven large flat skewers 550 that are placed across the fire bowl 600 and a top 602, a top edge 604 and a back edge 606 of the fire bowl 600 (FIG. 6) although any number of large, flat skewers 550 can be run across and be removably secured to the inverted t-shaped holder 440 and the detachable gear system 450. There is also a single small straight skewer 620 (FIG. 6) that is placed across the fire bowl 600 and a top 602, a top edge 604 and a back edge 606 of the fire bowl 600 (FIG. 6) although any number of small straight skewers 620 can be run across and be removably secured to the inverted t-shaped holder 440 and the detachable gear system 450.

FIG. 6 illustrates a front and top view of a fire bowl 600 of an adjustable portable grill, in accordance with one embodiment of the present invention.

The fire bowl 600 includes a top 602, a top edge 604, a back edge 606, a grill surface 610, a plurality of small straight skewers 620 and a rotisserie 630. The grill surface 610 is placed on top 602 of the fire bowl 600 and can be placed on any suitable location across the top 602 of the fire bowl 600. The small straight skewers 620 have a handle 622, a stem 624 and a distal end 626 and rest in a plurality of notches 605 disposed on the top edge 604 of the fire bowl 600 and food such as meat or vegetables can be punctured and slid onto the small straight skewers 620 and are the same small straight skewers 620 described and illustrated in FIG. 5B and its description. The rotisserie 630 is disposed on the back edge 606 of the fire bowl 600 and includes a plurality of apertures 632. The distal end 626 of the small straight skewers 620 are inserted into the apertures 632 which more specifically include 11 apertures, although the rotisserie 630 can include any number of apertures 632.

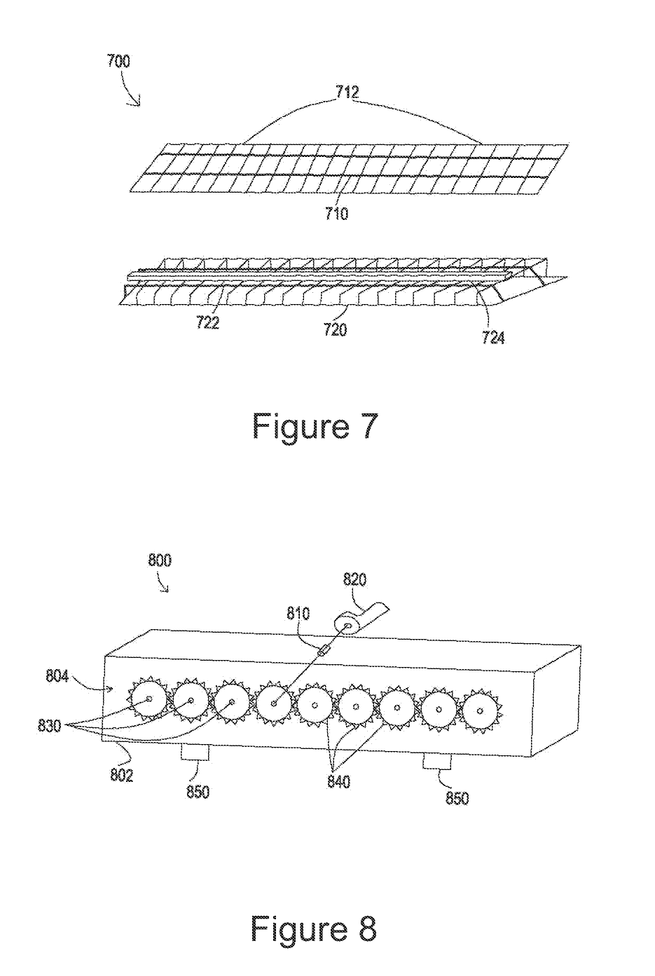

FIG. 7 illustrates a front view of a grill surface 700 of an adjustable portable grill, in accordance with one embodiment of the present invention.

The grill surface 700 illustrated and described in FIG. 7 is the same grill surface 610 illustrated and described in FIG. 6 and its description. The grill surface 700 includes a top portion 710 that includes a pair of grill surfaces 712 and an enclosed grill cage 720 with an open top 722 and a hollow rod 724. The top portion 710 is placed over the top 602 of the fire bowl 600 and rests on the top 602, the top edge 604 and the back edge 606 of the fire bowl 600. and is approximately 10 cm. in width and 3 mm. and 5 mm. in thickness. The top portion 710 is a traditional grilling mesh 714 that can cook and barbeque one or more steaks, hamburgers and other suitable grillable foods. The enclosed grill cage 720 holds any food being cooked such as meat and vegetables and other suitable foods and is approximately 3 cm. in depth and 3 mm. and 5 mm. in thickness. The enclosed grill cage 720 has an open top 722 which can be opened and locked secure. The hollow rod 724 is disposed on top of the open top 722 and receives a long rotisserie skewer (not shown) that is placed across the fire bowl 600 that rests on the inverted t-shaped holder 440 and a detachable gear system 450 that was previously illustrated and described in FIGS. 4A and 4B and its description.

FIG. 8 illustrates a front view of a rotisserie 800 of an adjustable portable grill, in accordance with one embodiment of the present invention.

The rotisserie 800 is the same rotisserie that is illustrated and described in FIG. 6 as 630 and its description.

The rotisserie 800 includes a bottom portion 802, a front facing 804, a horizontal stem 810, a motor holder 820, a plurality of apertures 830, a plurality of gears 840 and a pair of attachment hooks 850. The rotisserie 800 is a rectangular rotisserie gear mechanism but can also be any suitable rotisserie. The horizontal stem 810 is the same horizontal stem 216 described and illustrated in FIG. 2 and its description that is inserted into an electric powered motor 900 that is illustrated and described in FIG. 2 and FIG. 9 and their descriptions. The motor holder 820 holds an electric powered motor 900 and is the same motor holder 214 that is illustrated and described in FIG. 2 and its description. The apertures 830 include 11 or more apertures that are the same apertures 632 described and illustrated in FIG. 6 and its description. The apertures 830 receive the distal end (not shown) of the small skewers (not shown) that are inserted into the apertures 830 that can include any suitable number of apertures 830. The gears 840 are integral to the 11 or more apertures 830 and the horizontal stem 810 and assist in turning the distal end and the small skewers. The pair of attachment hooks 850 removably attaches the rotisserie 800 to the fire bowl 600 (FIG. 6).

FIG. 9A illustrates a front interior view of an electric powered motor 900 of an adjustable portable grill, in accordance with one embodiment of the present invention.

The electric powered motor 900 includes a motor 910 which works on battery as well as electric power. The battery operated motor 910 includes a battery casing 912, a square components casing 914 and an aperture 916 disposed on a front portion 915 of the square components casing 914 and a covering 920. The aperture 916 is on the other side of the components casing 914 in which stem 810 gets inserted into (FIG. 8) to power the adjustable portable grill 100.

FIG. 9B illustrates a front view of a battery powered motor 930 of an adjustable portable grill, in accordance with one embodiment of the present invention.

The battery powered motor 930 includes a stem 932, an on and off switch 934, one or more batteries 936 and a cord aperture 938. The rotating stem 932 is a generally square-shaped but can be any suitable shaped stem. The on and off switch 934 is a toggle switch but can be any suitable switch. The one or more batteries 936 can be any suitable size, type and quantity of portable battery such as a lithium battery or a standard alkaline battery. The cord aperture 938 is designed to accommodate a power cord inlet 942 from a power cord 946. The electric powered motor 930 includes a power cord inlet 942, an electric plug 944, a power cord 946 and a cord casing 948. The power cord inlet 932 in inserted into the cord aperture 938. The electric plug 944 can be inserted into any suitable power outlet (not shown). The power cord 946 extends from the power cord inlet 932 and provides power to the electric powered motor 940. The cord casing 948 contains the electric plug 944 that extends from the cord casing 948.

FIG. 9C illustrates a front view of an electric powered motor 950 of an adjustable portable grill, in accordance with one embodiment of the present invention.

The electric powered motor 950 includes a stem 952, a power cord 954, a power plug 956 and a power casing 958. The stem 952 is a generally rectangular-shaped stem that is inserted into the adjustable portable grill 100 but can be any other suitable type of stem. The power cord 954 extends from and provides power to the electric powered motor 930. The power plug 956 is at the distal end of the power cord 954 and can be inserted into any suitable power outlet (not shown). The power casing 958 receives the power cord 956 and stem 952 that extends from the power casing 958.

The adjustable portable grill can be used for different purposes:
a) The skewers on the top of the adjustable portable grill are thick and can be used for holding large chunks of meat like chicken, turkey, big spare ribs, and other suitable food. The height adjuster can help adjust the distance of the rotating skewers from the fire bowl even while the meat on the skewers are getting cooked without bringing the skewers out thereby avoiding any additional hassle. The height of these thick top skewers can be adjusted by an easy to use mechanism.
b) The skewers at the bottom of the adjustable portable grill are comparatively thin and flat for lighter meats, kabobs, vegetables, and other suitable foods.
c) A set of fish fork skewers are also included and are used for holding fish, vegetables, thin meat or any suitable food that might slip off a regular skewer.
d) A cage will be part of the adjustable portable grill. This cage is made up of grill mesh. The thick skewer goes into the hollow tube below the cage and passes all the way through the other end of the hollow tube, thereby making the cage firmly hold on to the thick skewer and when this thick skewer rotates the cage also rotates along with it. The cage is relatively hollow and has a door equal to its length which can be opened and filled with meat which cannot be put on skewers. Examples are fish, burger patties, fillets, steaks, sausages, and other suitable foods. Two cages can be used simultaneously in the adjustable portable grill.
e) The grill at the bottom can be used for conventional grilling purposes.

In order to allow the small skewers to rotate even while the grill mesh is placed on top of the BBQ, the grill is divided into two equal sized portions. So one of the grill portions can be taken out and the small skewers can be used in its place.

All skewers can be rotated manually or with the option of using a battery or an electrical motor.

1. The skewers fix into rotating slots. These slots are connected to moving gears, each gear's groove fits into its adjacent gear grooves, and the central gear rotates by a battery/electric operated portable motor, thereby rotating all the gears simultaneously.

2. The main lid of the BBQ is designed in such a shape that it does not restrict any skewer (small or thick skewers) from rotating even when it is in the closed position. Even if a cage is being used the lid will not restrict the cage from rotating. The lid will have a smoke door which could be opened or closed.

3. The BBQ provides one complete portable barbeque solution to people. Using this portable BBQ people could do their regular grilling, along with 2 levels of simultaneous rotisserie along with cage rotisserie barbequing. All this can be done at a home, while camping, at a park, at a picnic, etc. using the battery operated motors to rotate the skewers.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An adjustable portable grill, comprising:
a detachable gear system that includes a plurality of interlocking gears, a motor holder and a horizontal stem;
a height adjusting handle that includes a generally rectangular casing with a distal end, an outer side, a vertical moving handle disposed on said distal end of said rectangular casing, a screw handle, a horizontal slot disposed on said outer side, a vertical movable joint that is placed in said horizontal slot that is horizontally adjustably moved within said horizontal slot and a bottom rod that is provided to attach said movable joint to said fire bowl;
a plurality of adjustable detachable legs that include a hollow interior, a hollow tube movably inserted into said hollow interior of each said adjustable detachable leg, a manual screw that secures said each adjustable detachable leg at a desired height, an inverted u-shaped tube with two ends and a middle portion where said two ends are inserted into said hollow tubes of said adjustable detachable legs; and
a fire bowl with two sides that includes a top, a top edge, a back edge, a grill surface, a plurality of small skewers and a rotisserie.

2. The adjustable portable grill according to claim 1, wherein said detachable gear system is attached to either said sides of said fire bowl to rotate and accommodate a plurality of large skewers.

3. The adjustable portable grill according to claim 1, wherein said interlocking gears include 3 large moving apertures or slots that accommodate said large skewers.

4. The adjustable portable grill according to claim 1, wherein said motor holder contains and secures an electric powered or battery powered motor utilized to power said detachable gear system.

5. The adjustable portable grill according to claim 4, wherein said horizontal stem is inserted into an aperture of said electric powered or battery powered motor to allow said electric powered motor to rotate said gears of said detachable gear system.

6. The adjustable portable grill according to claim 1, wherein said vertical movable joint has a distal end that is attached to said middle portion of said inverted u-shaped tube.

7. The adjustable portable grill according to claim 1, wherein said detachable gear system is disposed on said u-shaped tube and is height adjustable by said height adjusting handle.

8. The adjustable portable grill according to claim 1, wherein said grill surface is placed on said top of said fire bowl and is placed across said top of said fire bowl.

9. The adjustable portable grill according to claim 1, wherein said small skewers have a handle, a stem and a distal end and rest in a plurality of notches disposed on said top edge of said fire bowl.

10. The adjustable portable grill according to claim 9, wherein said rotisserie is disposed on said back edge of said fire bowl and includes a plurality of apertures, wherein said distal end of said small skewers are inserted into said apertures.

11. An adjustable portable grill, comprising:
an inverted t-shaped holder with a perpendicular horizontal stem with a distal end and a horizontal portion with two ends wherein a slot that accommodates and removably secures a large skewer is disposed on said distal end of said perpendicular horizontal stem and disposed on each said end of said horizontal portion;
a height adjusting handle that includes a generally rectangular casing with a distal end, an outer side, a vertical moving handle disposed on said distal end of said rectangular casing, a screw handle, a horizontal slot disposed on said outer side, a vertical movable joint that is placed in said horizontal slot that is horizontally adjustably moved within said horizontal slot and a bottom rod that is provided to attach said movable joint to said fire bowl;
a plurality of adjustable detachable legs that include a hollow interior, a hollow tube movably inserted into said hollow interior of each said adjustable detachable leg, a manual screw that secures said each adjustable detachable leg at a desired height, an inverted u-shaped tube with two ends and a middle portion where said two ends are inserted into said hollow tubes of said adjustable detachable legs; and
a fire bowl with two sides that includes a top, a top edge, a back edge, a grill surface, a plurality of small skewers and a rotisserie that includes a bottom portion, a front facing, a horizontal stem, a motor holder, a plurality of apertures and a plurality of gears.

12. The adjustable portable grill according to claim 11, wherein said inverted t-shaped holder is disposed on said inverted u-shaped tube.

13. The adjustable portable grill according to claim 11, wherein said vertical movable joint has a distal end that is attached to said middle portion of said inverted u-shaped tube.

14. The adjustable portable grill according to claim 11, wherein said detachable gear system is disposed on said u-shaped tube and is height adjustable by said height adjusting handle.

15. The adjustable portable grill according to claim 11, wherein said grill surface is placed on said top of said fire bowl and is placed across said top of said fire bowl.

16. The adjustable portable grill according to claim 11, wherein said small skewers have a handle, a stem and a distal end and rest in a plurality of notches disposed on said top edge of said fire bowl.

17. The adjustable portable grill according to claim 16, wherein said rotisserie is disposed on said back edge of said fire bowl and includes a plurality of apertures, wherein said distal end of said small skewers are inserted into said apertures.

18. The adjustable portable grill according to claim 16, wherein said horizontal stem is inserted into an electric powered or a battery powered motor.

19. The adjustable portable grill according to claim 11, wherein said apertures include 11 apertures that receive said distal end of said small skewers.

20. The adjustable portable grill according to claim 11, wherein said gears are integral to said 11 apertures and said horizontal stem.
